(19) United States
(12) Patent Application Publication
(10) Pub. No.: US 2024/0257003 A1
(43) Pub. Date: Aug. 1, 2024

(54) TRANSPORTATION SCHEDULE GENERATION SYSTEM AND METHOD

(71) Applicant: Hitachi, Ltd., Tokyo (JP)

(72) Inventors: Akane SETO, Tokyo (JP); Junko HOSODA, Tokyo (JP); Kazuya UYAMA, Tokyo (JP); Hikaru KOKUBU, Tokyo (JP)

(21) Appl. No.: 18/417,272

(22) Filed: Jan. 19, 2024

(30) Foreign Application Priority Data
Jan. 27, 2023 (JP) 2023-010836

(51) Int. Cl. G06Q 10/0631; G06Q 50/40

(52) U.S. Cl. CPC G06Q 10/06313; G06Q 50/40

(57) ABSTRACT

A plurality of combinations of transportation schedule proposals of loads in which the loads to be transported are transported without the transportation vehicles running out of electricity and charging schedule proposals of the transportation vehicles are generated based on an original transportation schedule and a remaining charging amount of each of the present transportation vehicles. At least a delivery delay of the loads is evaluated for each of the generated combinations of the transportation schedule proposals and the charging schedule proposals and a combination of the transportation schedule proposal and the charging schedule proposal is selected based on an evaluation result.

### CROSS-REFERENCE TO RELATED APPLICATION

The present application claims priority from Japanese application JP2023-010836, filed on Jan. 27, 2023, the content of which is hereby incorporated by reference into this application.

### BACKGROUND OF THE INVENTION

### 1. Field of the Invention

The present invention relates to a transportation schedule generation system and method and is suitable for application to a transportation schedule generation apparatus that generates a transportation schedule in a transportation service transporting loads by motor vehicles.

### 2. Description of Related Art

In recent years, private automobiles were electrified. In the transportation field, transportation vehicles were also electrified.

To inhibit driving vehicles moving between points from running out of electricity, there is a technique for determining charging, exchange, and none of charging and exchange at a first point of a battery mounted in a driving vehicle based on a present time and a predetermined time when the driving vehicle located at the first point moves to a second point which is a next destination until the predetermined time. For example, there is a technique disclosed in JP2022-59985A.

In a transportation service, a case where motor vehicles are used as transportation vehicles will be considered. In the transportation service, loads are normally transported according to transportation schedules designed weekly or daily. In the transportation service, however, for example, there are cases in which an order (transportation request) for transporting an additional load is received on the same day and a load is picked up at a third point which was not scheduled until then while moving from a first point to a second point, and cases in which a power consumption amount for cooling the inside of a vehicle is increased more than an expected power consumption amount since a temperature is higher than a predicted temperature. Unexpected events in prior transportation schedules can occur.

When such unexpected events in schedules occur and the events are events related to customers, drivers, or transportation vehicles and particularly events which cannot be handled by drivers by themselves, it is conceivable that the drivers call operators of the transportation service to inform the operators of the occurring events, the operators receiving the calls manually change some or all of the transportation schedules of the transportation service including transportation schedules of other transportation vehicles and notify the changed transportation schedules to the drivers of the transportation vehicles.

Incidentally, when the transportation service is all or partially changed, as described above, a traveling range of a motor vehicle is short, such that when the transportation schedule is changed rashly, there is concern of a remaining charging amount of a transportation vehicle running out of electricity and becoming zero. When the transportation vehicle runs out of electricity, a problem occurs in that a logistics cost increases to handle a transportation vehicle itself running out of electricity or a load scheduled to be transported.

For example, when a transportation schedule is changed, it is necessary to inhibit delivery delay and an operation time increase of the transportation vehicle. This is because, when delivery delay occurs, re-transportation is required depending on cases such that there is concern of the logistics cost increasing accordingly. When an operation time of the transportation vehicle increases, overtime work of a driver occurs such that there is concern of the logistics cost increasing accordingly.

When a transportation schedule is changed, it is desirable to inhibit an increase in an operation time deviation of each transportation vehicle from the viewpoint of an operation of transporting drivers. This is because when an operation time deviation of a transportation vehicle increases, labor times of drivers become unequal, and as a result, the labor times of some drivers are lengthened and there is concern of a labor environment deteriorating and the logistics cost increasing.

### SUMMARY OF THE INVENTION

There are provided a transportation schedule generation system and method capable of generating a new transportation schedule to inhibit an increase in a logistics cost in relation to transportation of a load by a motor vehicle.

To solve the foregoing problem, according to an aspect of the present invention, a transportation schedule generation system that re-generates a pre-generated transportation schedule of loads by transportation vehicles which are motor vehicles includes: a schedule proposal generation unit configured to generate a plurality of combinations of transportation schedule proposals of the loads and charging schedule proposals of the transportation vehicles in which the loads to be transported are transported without the transportation vehicles running out of electricity based on original transportation schedules and a remaining charging amount of each of present transportation vehicles; and a schedule proposal evaluation unit configured to evaluate at least a delivery delay of the loads for each of the generated combinations of the transportation schedule proposals and the charging schedule proposals and select a combination of the transportation schedule proposal and the charging schedule proposal based on an evaluation result.

According to another aspect of the present invention, a transportation schedule generation method performed in a transportation schedule generation system including a transportation schedule generation apparatus that re-generates a pre-generated transportation schedule of loads by transportation vehicles which are motor vehicles includes: a first step of generating a plurality of combinations of transportation schedule proposals of the loads and charging schedule proposals of the transportation vehicles in which the loads to be transported are transported without the transportation vehicles running out of electricity based on original transportation schedules and a remaining charging amount of each of present transportation vehicles; and a second step of evaluating at least a delivery delay of the loads for each of the generated combinations of the transportation schedule proposals and the charging schedule proposals and selecting a combination of the transportation schedule proposal and the charging schedule proposal based on an evaluation result.

According to the transportation schedule proposal generation system and method according to the aspects of the present invention, it is possible to select, as a new transportation schedule, an optimum combination of a transportation schedule proposal and a charging schedule proposal in which the delivery delay of the loads, and the operation time increase and the operation time deviation of the transportation vehicles are inhibited.

According to the present invention, it is possible to implement a transportation schedule generation system and method capable of generating a new transportation schedule to inhibit an increase in a logistics cost in relation to transportation of a load by a motor vehicle.

### BRIEF DESCRIPTION OF THE DRAWINGS

FIG. 1 is a block diagram illustrating an overall configuration of a transportation schedule generation system according to an embodiment;

FIG. 2 is a block diagram illustrating a logical configuration of a transportation schedule generation apparatus according to the embodiment;

FIG. 3 is a table illustrating a configuration example of a load information table;

FIG. 4 is a table illustrating a configuration example of a vehicle information table;

FIG. 5 is a table illustrating a configuration example of a base point information table;

FIG. 6 is a table illustrating a configuration example of a berth information table;

FIG. 7 is a table illustrating a configuration example of a charging stand information table;

FIG. 8 is a table illustrating a configuration example of a movement cost information table;

FIG. 9 is a table illustrating a configuration example of a transportation schedule information table;

FIG. 10 is a table illustrating a configuration example of a vehicle present-status information table;

FIG. 11 is a table illustrating a configuration example of an evaluation information table;

FIG. 12 is a table illustrating a configuration example of a transportation schedule proposal information table;

FIG. 13 is a table illustrating a configuration example of a charging schedule proposal information table;

FIG. 14 is a flowchart illustrating a processing procedure of a transportation and charging schedule proposal generation and evaluation process;

FIG. 15 is a flowchart illustrating a processing procedure of a transportation and charging schedule proposal generation process;

FIG. 16 is a flowchart illustrating a processing procedure of a schedule proposal evaluation process;

FIG. 17 is a diagram illustrating a screen configuration example of a transportation schedule proposal display screen;

FIG. 18 is a diagram illustrating a screen configuration example of a charging schedule proposal display screen;

FIG. 19 is a diagram illustrating a screen configuration example of a transportation schedule display screen; and

FIG. 20 is a diagram illustrating a screen configuration example of a base point schedule display screen.

### DESCRIPTION OF EMBODIMENTS

Hereinafter, an embodiment of the present invention will be described in detail with reference to the drawings.

### (1) Configuration of Transportation Schedule Generation System According to Embodiment

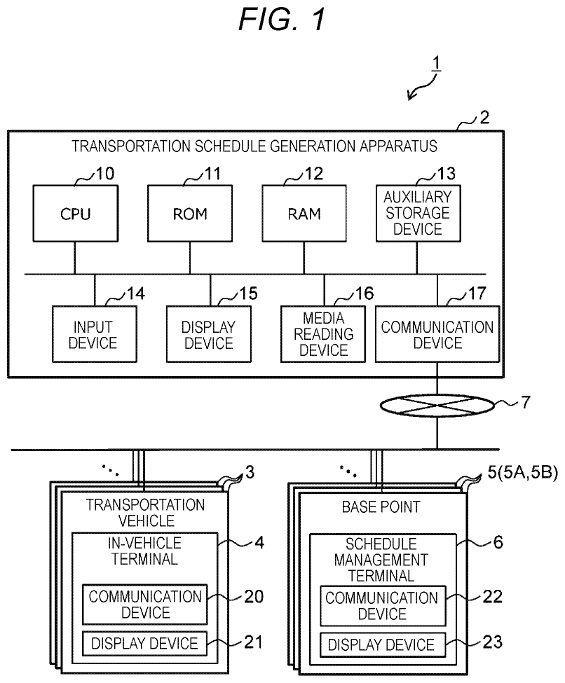

In FIG. 1, reference numeral 1 denotes an overall transportation schedule generation system according to the embodiment. The transportation schedule generation system 1 includes a transportation schedule generation apparatus 2, an in-vehicle terminal 4 mounted in each transportation vehicle 3 which is a motor vehicle, and a schedule management terminal 6 provided in each of base points 5 such as a collection and distribution base point 5A and a charge base point 5B. The motor vehicle is, for example, an electric vehicle (EV).

The collection and distribution base point 5A is a base point at which load collection and delivery are performed in the transportation vehicle 3, and the charging base point 5B is a base point at which a charging stand for charging the transportation vehicle 3 is installed. There may be cases in which the charging stand is installed at the collection and distribution base point 5A.

The transportation schedule generation apparatus 2 is configured with a general-purpose computer apparatus that includes a central processing unit (CPU) 10, a read only memory (ROM) 11, a random access memory (RAM) 12, an auxiliary storage device 13, an input device 14, a display device 15, a media reading device 16, and a communication device 17.

The CPU 10 is a processor in charge of operation control of the entire transportation schedule generation apparatus 2. The ROM 11 is a nonvolatile semiconductor memory that stores a program or the like necessary for running the transportation schedule generation apparatus 2. The RAM 12 is a volatile semiconductor memory used as a working memory of the CPU 10.

The auxiliary storage device 13 is configured with, for example, a nonvolatile storage device such as a hard disk device or a solid state drive (SSD) and stores various programs, data required to be stored for a long time, or the like. Various processes of the entire transportation schedule generation apparatus 2 to be described below are performed by reading programs stored in the auxiliary storage device 13 from the auxiliary storage device 13 to the RAM 12 when running the transportation schedule generation apparatus 2 or as necessary and causing the CPU 10 to execute the programs read to the RAM 12.

The input device 14 is configured with a mouse, a keyboard, or the like and is used when a user inputs various types of information or various instructions to the transportation schedule generation apparatus 2. The display device 15 is configured with, for example, a liquid crystal display, an organic electro-luminescence (EL) display, or the like and is used to display various types of information. Instead of the input device 14 and the display device 15, a touch panel in which an input device and a display device are integrated may be applied.

The media reading device 16 is a reader/writer device that reads and writes data from and on a portable storage medium such as a universal serial bus (USB) or a secure digital (SD) card. The communication device 17 is a communication device that has a function of exchanging information or the like with each in-vehicle terminal 4 or each schedule management terminal 6 via a wired or wireless network 7.

On the other hand, the in-vehicle terminal 4 is configured with a wireless communication terminal device that includes a communication device 20 which is a wireless communication terminal and a display device 21 configured with a liquid crystal panel, an organic EL panel, or the like. The in-vehicle terminal 4 transmits information such as a present position of the transportation vehicle 3 on which the in-vehicle terminal 4 is mounted or a present charging status of the transportation vehicle 3 periodically or in response to a request from the transportation schedule generation apparatus 2. The in-vehicle terminal 4 displays information transmitted from the transportation schedule generation apparatus 2 via the network 7 on the display device 21.

The schedule management terminal 6 is configured with a computer apparatus that includes a communication device 22 which is a wired or wireless communication terminal and a display device 23 configured with a liquid crystal display, an organic EL display, or the like. The schedule management terminal 6 transmits necessary information regarding the base point 5 in which the schedule management terminal 6 is installed to the transportation schedule generation apparatus 2 via the network 7 periodically or in response to a request from the transportation schedule generation apparatus 2, or displays information transmitted from the transportation schedule generation apparatus 2 via the network 7 on the display device 23.

### (2) Transportation and Charging Schedule Proposal Generation and Evaluation Function According to Embodiment

Next, a transportation and charging schedule proposal generation and evaluation function according to the embodiment mounted on the transportation schedule generation apparatus 2 will be described. The transportation and charging schedule proposal generation and evaluation function is a function of generating a plurality of combinations of transportation schedule proposals in which unexpected events are taken into consideration when the unexpected events occur in transportation schedules generated weekly or daily in advance and charging schedules (hereinafter referred to as charging schedule proposals) for charging each transportation vehicle 3 to not run out of electricity when executing the transportation schedule proposals.

In addition to or instead of the charging of batteries included in the transportation vehicles 3 so that each transportation vehicle 3 does not run out of electricity, the batteries included in the transportation vehicles 3 may be exchanged with charged batteries. The charging schedule proposal may include a schedule in which the batteries of the transportation vehicles 3 are exchanged in addition to a schedule in which the batteries of the transportation vehicles 3 are charged. A schedule including at least one of the schedule in which the batteries of the transportation vehicles 3 are charged and the schedule in which the batteries of the transportation vehicles 3 are exchanged may be referred to as a supply schedule (or a supply schedule proposal). Hereinafter, an example in which the charging schedule proposal is generated will be mainly described.

The transportation schedule generation apparatus 2 evaluates each of three evaluation items including “delivery delay”, “operation time increase”, and “operation time deviation” for each generated combination of the transportation schedule proposals and the charging schedule proposals based on the transportation and charging schedule proposal generation and evaluation function, and presents a more highly evaluated combination of the transportation schedule proposal and the charging schedule proposal as a new transportation schedule to users such as operators of the transportation service or drivers of each transportation vehicle and staffs of each base point based on evaluation results of the evaluation items.

Here, the “transportation schedule proposal” is a schedule proposal related to a status of each transportation vehicle 3, such as departure, collection, delivery, charging, and arrival at each collection and distribution base point 5A. The “charging schedule proposal” is a schedule proposal related to charging of each transportation vehicle 3 at each charging base point 5B.

Here, the “delivery delay” is a sum time of delivery delay of each load occurring when a transportation service is performed according to the generated transportation schedule proposal and charging schedule proposal. The “operation time increase” is a sum of times of the transportation vehicles 3 increased when the transportation service is performed according to the generated transportation schedule proposal and the charging schedule proposal with respect to the operation time of each transportation vehicle 3 in the transportation schedule generated weekly or daily in advance. The “operation time deviation” is a deviation of an operation time between the transportation vehicles 3 when the transportation service is performed according to the generated transportation schedule proposal and charging schedule proposal.

When a new transportation schedule is generated, it is preferable that values of all the evaluation items of the “delivery delay”, the “operation time increase”, and the “operation time deviation” are small, but in some cases, it is difficult to minimize the values of all the evaluation items. Accordingly, the transportation schedule generation apparatus 2 is configured such that a weight (weight coefficient) desired in each evaluation item can be set, each combination of the transportation schedule proposal and the charging schedule proposal is overall evaluated based on the sum value of multiplication results obtained by multiplying the values of the evaluation items by the weight coefficients set in each item, and a most highly evaluated combination is selected as a new transportation schedule.

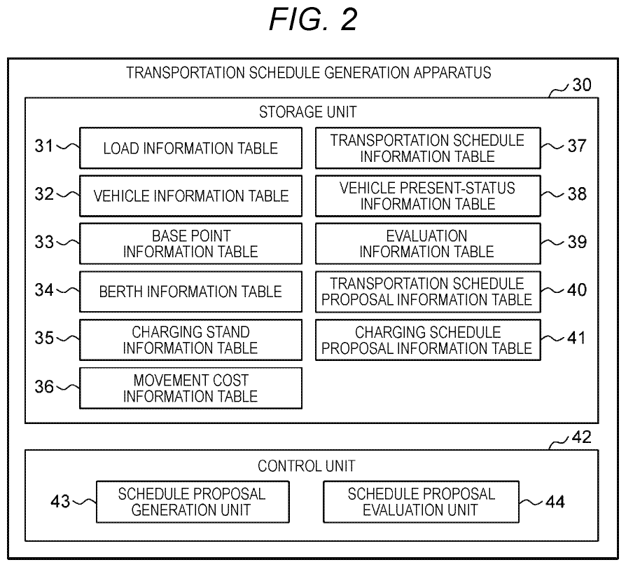

As mechanisms for implementing such transportation and charging schedule proposal generation and evaluation function, as illustrated in FIG. 2, the transportation schedule generation apparatus 2 includes a load information table 31, a vehicle information table 32, a base point information table 33, a berth information table 34, a charging stand information table 35, a movement cost information table 36, a transportation schedule information table 37, a vehicle present-status information table 38, an evaluation information table 39, a transportation schedule proposal information table 40, and a charging schedule proposal information table 41 each stored in a storage unit 30, and a control unit 42 that includes a schedule proposal generation unit 43 and a schedule proposal evaluation unit 44. The storage unit 30 is a concept of storage regions provided by the ROM 11, the RAM 12, and the auxiliary storage device 13. The control unit 42 is a concept of a function of the CPU 10.

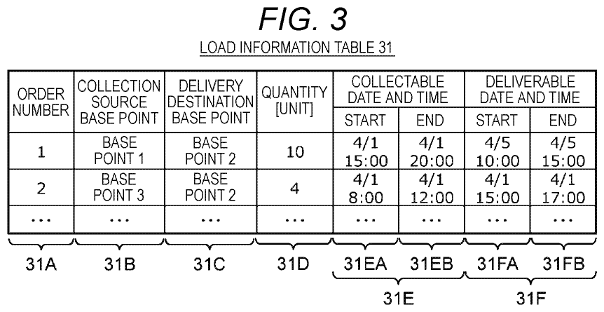

The load information table 31 is a table used to manage information regarding each load for which a request for transportation is given, in which the table is generated in advance, and is provided to the transportation schedule generation apparatus 2. As illustrated in FIG. 3, the load information table 31 includes an order number field 31A, a collection source base point name field 31B, a delivery destination base point name field 31C, a quantity field 31D, a collectable date and time field 31E, and a deliverable date and time field 31F. In the load information table 31, one record (row) corresponds to a transportation request (hereinafter simply referred to an order) of one set of load.

In the order number field 31A, a unique identification number (order number) given to a corresponding order is stored. In the collection source base point name field 31B, a name of the collection and distribution base point 5A (base point name) at which the load designated in the order is collected is stored. In the delivery destination base point name field 31C, a base point name of the collection and distribution base point 5A that is a transportation destination of the load designated in the order is stored.

In the quantity field 31D, the quantity of loads requested to be transported in the order is stored. Here, instead of the quantity of loads, a total weight or a total volume of the loads may be managed in the load information table 31, or combinations of some or all of the quantity, and the total weight, and the total volume of the loads may be managed in the load information table 31.

The collectable date and time field 31E is divided into a start field 31EA and an end field 31EB. In the start field 31EA and the end field 31EB, a start date and time and an end date and time of a period in which the load should be collected are stored respectively. Similarly, the deliverable date and time field 31F is divided into a start field 31FA and an end field 31FB. In the start field 31FA and the end field 31FB, a start date and time and an end date and time of a period in which the load should be delivered are stored respectively.

Accordingly, in the case of the example of FIG. 3, an order to which an order number “1” is given indicates a request for transporting “10” loads from the collection and distribution base point 5A to which a base point code “base point 1” is given to the collection and distribution base point 5A to which a base point code “base point 2” is given. In FIG. 3, a period in which the loads should be collected from the collection and distribution base point 5A called “base point 1” is “4/1 15:00” to “4/1 20:00” and a period in which the loads should be delivered to the collection and distribution base point 5A called “base point 2” is “4/5 10:00” to “4/5 15:00”.

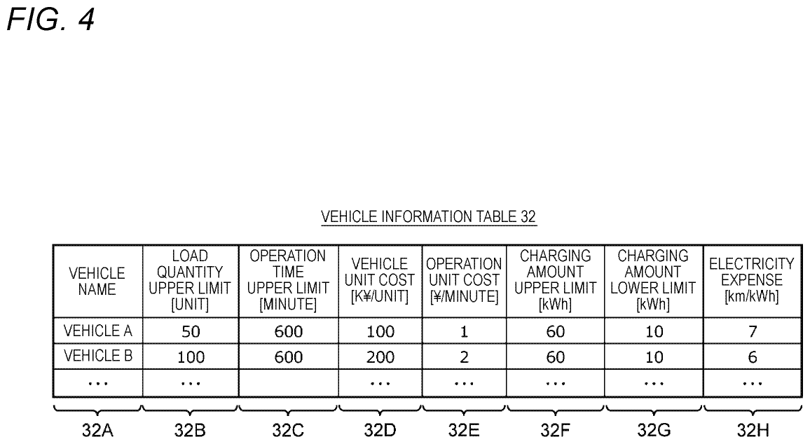

The vehicle information table 32 is a table used to manage the transportation vehicle 3 which can be used to transport a load, in which the table is generated in advance, and is provided to the transportation schedule generation apparatus 2. As illustrated in FIG. 4, the vehicle information table 32 includes a vehicle name field 32A, a load quantity upper limit field 32B, an operation time upper limit field 32C, a vehicle unit cost field 32D, an operation unit cost field 32E, a charging amount upper limit field 32F, a charging amount lower limit field 32G, and an electricity expense field 32H. In the vehicle information table 32, one record (row) corresponds to one transportation vehicle 3.

In the vehicle name field 32A, a name of the transportation vehicle 3 (vehicle name) given to the corresponding transportation vehicle 3 is stored. In the load quantity upper limit field 32B, the upper limit quantity of the loads which can be carried in the transportation vehicle 3 (load quantity upper limit) is stored. Instead of the load quantity upper limit, a load weight upper limit indicating an upper limit of a weight which can be carried in the transportation vehicle 3 or a load volume upper limit indicating an upper limit of a volume which can be carried in the transportation vehicle 3 may be managed in the vehicle information table 32. Combinations of some or all of the load quantity upper limit, the load weight upper limit, and the load volume upper limit may be managed in the vehicle information table 32. In the operation time upper limit field 32C, an upper limit of a time in which the transportation vehicle 3 can be operated is stored.

In the vehicle unit cost field 32D, a vehicle unit cost indicating a preparation fee necessary to prepare the transportation vehicle 3 is stored. In the operation unit cost field 32E, an operation unit cost indicating a use fee per unit time of the transportation vehicle 3 is stored.

In the charging amount upper limit field 32F, a charging amount upper limit which is an upper limit of a charging amount of the transportation vehicle 3 is stored. In the charging amount lower limit field 32G, a charging amount lower limit which is a minimum charging amount necessary to operate the transportation vehicle 3 is stored. In the electricity expense field 32H, a movement distance per unit consumption power amount of the transportation vehicle 3 is stored.

Accordingly, in the case of the example of FIG. 4, the transportation vehicle 3 called “vehicle A” has a load quantity upper limit of “50”, a vehicle unit cost of “100k” yen, an operation unit cost of “1” yen/minute, a charging amount upper limit of “60” kWh, a charging amount lower limit of “10” kWh, and an electricity expense of “7” km/kWh.

The base point information table 33 is a table used to manage each base point 5, in which the table is generated in advance, and is provided to the transportation schedule generation apparatus 2. As illustrated in FIG. 5, the base point information table 33 includes a base point name field 33A, a collection and delivery time field 33B, a position field 33C, a number of berths field 33D, and a charging amount upper limit field 33E. In the base point information table 33, one record (row) corresponds to one base point 5.

In the base point name field 33A, a base point name of the corresponding base point 5 is stored. In the collection and delivery time field 33B, when the base point 5 is the collection and distribution base point 5A, an average time necessary for collection or delivery per load at the base point 5 is stored. Here, an average time necessary for the collection and an average time necessary for the delivery may be managed separately in the base point information table 33.

The position field 33C is divided into a latitude field 33CA and a longitude field 33CB. In the latitude field 33CA, latitude of the corresponding base point 5 is stored. In the longitude field 33CB, longitude of the base point 5 is stored. In the number of berths field 33D, the number of berths in the base point 5 is stored. In the charging amount upper limit field 33E, when a charging stand is installed at the base point 5, a charging amount upper limit which is an upper limit of an electric amount with which charging is possible per unit time at the base point 5 is stored.

Accordingly, in the case of the example of FIG. 5, the base point 5 called “base point 1” is located at a position at which latitude is “33° 36′ 23″” and longitude is “130° 25′ 05″”. At the base point 5, “5” berths are located, an average time necessary for collection or delivery is “0.5” min/unit, and a charging amount upper limit is “100” kWh.

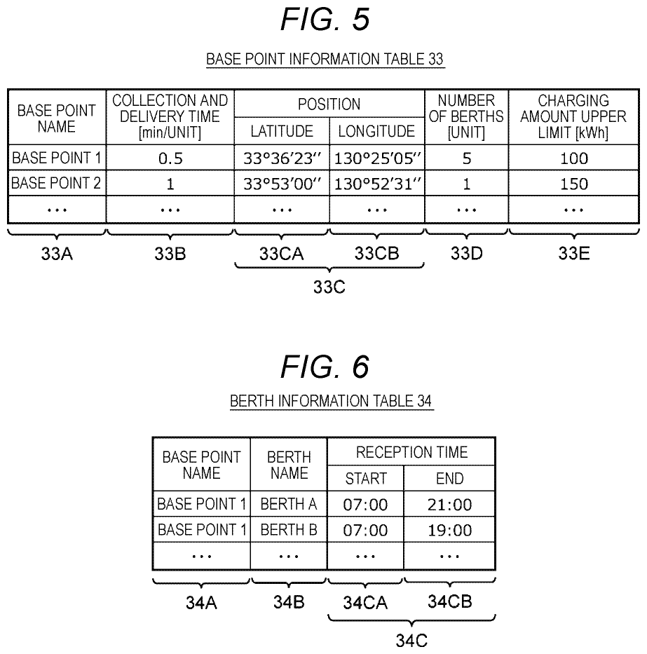

The berth information table 34 is a table used to manage berths installed at each base point 5, in which the table is generated in advance, and is provided to the transportation schedule generation apparatus 2. As illustrated in FIG. 6, the berth information table 34 includes a base point name field 34A, a berth name field 34B, and a reception time field 34C. In the berth information table 34, one record (row) corresponds to one berth installed at any base point 5.

In the base point name field 34A, a base point name of the base point 5 at which the corresponding berth is installed is stored. In the berth name field 34B, a name of the corresponding berth (berth name) is stored. The reception time field 34C is divided into a start field 34CA and an end field 34CB. In the start field 34CA, a period of time (period of reception time) at which the transportation vehicle 3 can be received at the corresponding berth is stored. In the end field 34CB, an end time of the period of reception time is stored.

Accordingly, in the case of the example of FIG. 6, for example, a berth called “berth A” is installed at the base point 5 called “base point 1”, and the reception time of the berth is from “07:00” to “21:00”.

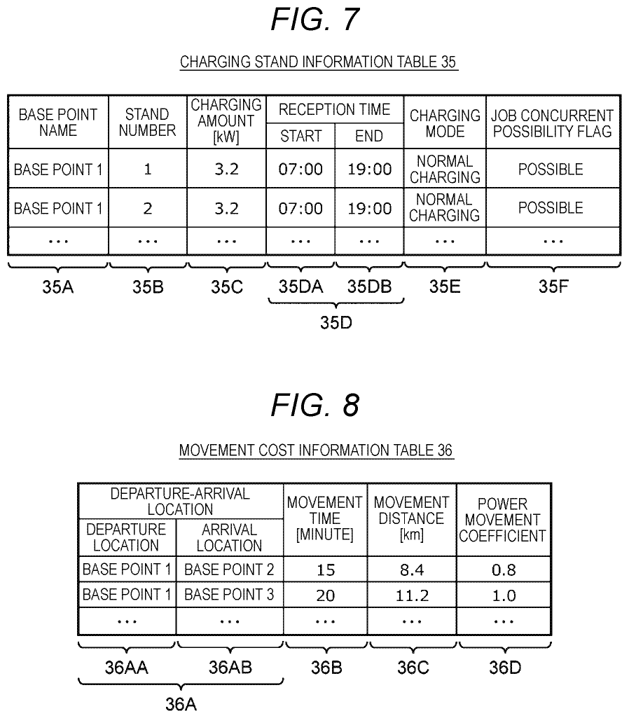

The charging stand information table 35 is a table used to manage a charging stand installed at each base point 5, in which the table is generated in advance, and is provided to the transportation schedule generation apparatus 2. As illustrated in FIG. 7, the charging stand information table 35 includes a base point name field 35A, a stand number field 35B, a charging amount field 35C, a reception time field 35D, a charging mode field 35E, and a job concurrent possibility flag field 35F. In the charging stand information table 35, one record (row) corresponds to one charging stand.

In the base point name field 35A, a base point name of the base point 5 at which the corresponding charging stand is installed is stored. In the stand number field 35B, a unique number given to the charging stand (stand number) is stored. In the charging amount field 35C, a charging amount per unit time which is chargeable at the charging stand is stored.

The reception time field 35D is divided into a start field 35DA and an end field 35DB. In the start field 35DA, a start time of the period of time in which the corresponding charging stand can be used is stored. In the end field 35DB, an end time of the period of time in which the stand can be used is stored. In the charging mode field 35E, charging modes which can be used in the charging stand are stored. The charging modes include a normal charging mode in which charging is performed at a normal speed and a quick charging mode in which quick charging is performed.

In the job concurrent possibility flag field 35F, when the charging stand is installed at the collection and distribution base point 5A, a flag indicating whether collection or delivery can be performed concurrently with charging (job concurrent possibility flag) is stored. The job concurrent possibility flag is set to “possible” when collection or delivery can be performed concurrently with charging. The job concurrent possibility flag is set to “impossible” when collection or delivery cannot be performed concurrently with charging.

Accordingly, in the case of the example of FIG. 7, a charging stand to which a stand number called “1” is given is installed at the base point 5 with the base point name called “base point 1”, corresponds to only “normal charging”, and a charging amount up to “3.2” kW per unit time is possible. A period of time in which the charging stand can be used is “07:00” to “19:00” and collection or delivery can be performed concurrently with charging.

The movement cost information table 36 is a table used to manage a cost and the like necessary for movement from a certain base point 5 to another base point 5, in which the table is generated in advance, and is provided to the transportation schedule generation apparatus 2. As illustrated in FIG. 8, the movement cost information table 36 includes a departure-arrival location field 36A, a movement time field 36B, a movement distance field 36C, and a power movement coefficient field 36D. In the movement cost information table 36, one record (row) corresponds to one route from a base point 5 to another base point 5.

The departure-arrival location field 36A is divided into a departure location field 36AA and an arrival location field 36AB. In the departure location field 36AA, a base point name of the base point 5 which is a departure location of the corresponding route is stored. In the arrival location field 36AB, a base point name of the base point 5 which is an arrival location of the route is stored.

In the movement time field 36B, an average movement time necessary for the transportation vehicle 3 to move at a legal speed from the departure location to the arrival location along the route is stored. In the movement distance field 36C, a movement distance from the departure location to the arrival location along the route is stored. In the power movement coefficient field 36D, a power movement coefficient indicating how much a power efficiency is good is stored. For example, in FIG. 4, electricity expense of the vehicle A is “7” kw/kWh. When moving from “base point 1” to “base point 2”, the transportation vehicle 3 can move only by “0.8” times compared to standard efficiency. When moving from “base point 1” to “base point 3”, the transportation vehicle 3 can move by “1.0” times equal to standard efficiency.

Accordingly, in the case of the example of FIG. 8, a distance from “base point 1” to “base point 2” is “8.4” km, an average movement time is “15” minutes, and a power consumption cost is “0.8”.

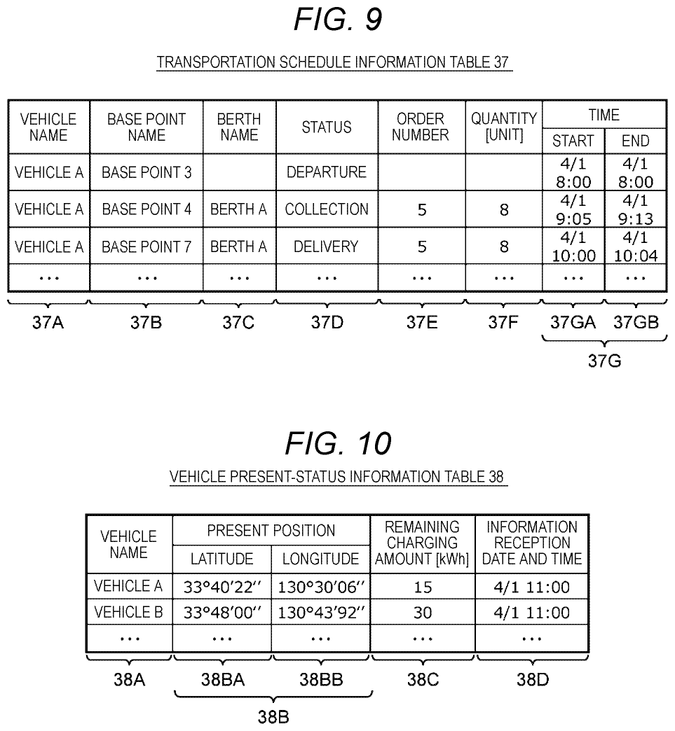

The transportation schedule information table 37 is a table used to manage a transportation schedule on the same day generated weekly or daily in advance, in which the table is generated in advance, and is provided to the transportation schedule generation apparatus 2. As illustrated in FIG. 9, the transportation schedule information table 37 includes a vehicle name field 37A, a base point name field 37B, a berth name field 37C, a status field 37D, an order number field 37E, a quantity field 37F, and a time field 37G. In the transportation schedule information table 37, one record (row) corresponds to one state of one transportation vehicle 3 for which the transportation schedule is generated.

In the vehicle name field 37A, a vehicle name of the corresponding transportation vehicle 3 is stored. In the base point name field 37B, a base point name of the base point 5 at which the transportation vehicle 3 departs, collects loads, delivers the loads, is charged, or arrives. In the berth name field 37C, a berth name of a berth which should be used by the transportation vehicle 3 at the base point 5 is stored. In the status field 37D, a “status” indicating a job or the like performed by the transportation vehicle 3 at the base point 5 is stored. As the “status” here, there is departure, collection, delivery, charging, or arrival.

In the order number field 37E, an order number of an order in which a corresponding job or the like is performed is stored. In the quantity field 37F, the quantity of loads designated in the order is stored. Instead of the quantity of loads, a total weight or a total volume of the loads may be managed in the transportation schedule information table 37. Combinations of some or all of the quantity of loads, the total weight, and the total volume may be managed in the transportation schedule information table 37.

The time field 37G is divided into a start field 37GA and an end field 37GB. In the start field 37GA, a date and time at which a status (job or the like) stored in the status field 37D starts is stored. In the end field 37GB, a date and time at which the status (job or the like) ends is stored.

Accordingly, in the case of the example of FIG. 9, a transportation schedule is generated in which the transportation vehicle 3 called “vehicle A” “departs” from the base point 5 called “base point 3” at “4/1 8:00”, “collects” “8” loads in the berth called “berth A” of the base point 5 (here, the collection and distribution base point 5A) called “base point 4” between “4/1 9:05” and “4/1 9:13” according to the order of which the order number is “5”, and “delivers” the loads in the berth called “berth A” of the base point (here, the collection and distribution base point 5A) called “base point 7” between “4/1 10:00” and “4/1 10:04”.

The vehicle present-status information table 38 is a table that is acquired by the transportation schedule generation apparatus 2 through a notification or the like from each transportation vehicle 3 to be managed, and is used to manage a present status of the transportation vehicle 3. As illustrated in FIG. 10, the vehicle present-status information table 38 includes a vehicle name field 38A, a present position field 38B, a remaining charging amount field 38C, and an information reception date and time field 38D. In the vehicle present-status information table 38, one record (row) corresponds to one transportation vehicle 3 to be managed.

In the vehicle name field 38A, a vehicle name of the corresponding transportation vehicle 3 is stored. The present position field 38B is divided into a latitude field 38BA and a longitude field 38BB. In the latitude field 38BA and the longitude field 38BB, latitude and longitude of the transportation vehicle 3 are stored respectively. In the remaining charging amount field 38C, a present remaining charging amount of the transportation vehicle 3 is stored. In the information reception date and time field 38D, a date and time at which the information is received is stored. In the information reception date and time field 38D, instead of or in addition of the date and time at which the information is received, a date and time at which the transportation vehicle 3 acquires the information or a date and time at which the information is transmitted may be stored.

As information indicating a present position of the transportation vehicle 3, combinations of some or all of the base point name of the base point 5 closest to the present position of the corresponding transportation vehicle 3, a distance from the base point 5, and a movement time from the base point 5 may be applied instead of latitude and longitude.

Accordingly, in the case of the example of FIG. 10, the transportation vehicle 3 called “vehicle A” is located at a place where longitude is “33° 40′ 22″” and longitude is “130° 30′ 06″” at the time point and a remaining charging amount is “15” kWh.

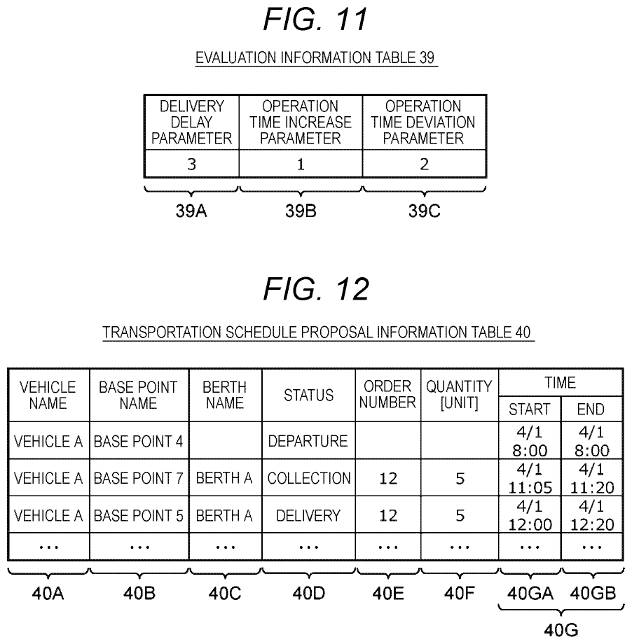

The evaluation information table 39 is a table used to manage parameters indicating magnitude of an influence of each of a “delivery delay”, an “operation time increase”, and an “operation time deviation” which are three evaluation items used at the time of evaluation of the transportation schedule proposal and the charging schedule proposal, in which the table is generated in advance, and is provided to the transportation schedule generation apparatus 2. As illustrated in FIG. 11, the evaluation information table 39 includes a delivery delay parameter field 39A, an operation time increase parameter field 39B, and an operation time deviation parameter field 39C.

In the delivery delay parameter field 39A, a delivery delay parameter (the above-described weight coefficient for the “delivery delay” when the transportation schedule proposal and the charging schedule proposal are evaluated) indicating magnitude of an influence of the “delivery delay” on a logistics cost is stored. In the operation time increase parameter field 39B, an operation time increase parameter (the above-described weight coefficient for the “operation time increase” when the transportation schedule proposal and the charging schedule proposal are evaluated) indicating magnitude of the “operation time increase” on the logistics cost is stored. In the operation time deviation parameter field 39C, an operation time deviation parameter (the above-described weight coefficient for the “operation time deviation” when the transportation schedule proposal and the charging schedule proposal are evaluated) indicating magnitude of the operation time deviation between the transportation vehicles 3 on the logistics cost is stored.

Accordingly, in the case of the example of FIG. 11, the magnitudes of the delivery delay parameter, the operation time increase parameter, and the operation time deviation parameter are set to “3”, “1”, and “2”, respectively.

The transportation schedule proposal information table 40 is a table used to manage a transportation schedule proposal generated when an unexpected event occurs in a transportation schedule designed weekly or daily in advance. As illustrated in FIG. 12, the transportation schedule proposal information table 40 includes a vehicle name field 40A, a base point name field 40B, a berth name field 40C, a status field 40D, an order number field 40E, a quantity field 40F, and a time field 40G.

The transportation schedule proposal information table 40 has a similar configuration to the transportation schedule information table 37. Thus, in the vehicle name field 40A, the base point name field 40B, the berth name field 40C, the status field 40D, the order number field 40E, the quantity field 40F, and the time field 40G, information regarding the transportation schedule proposal similar to the information stored in the vehicle name field 37A, the base point name field 37B, the berth name field 37C, the status field 37D, the order number field 37E, the quantity field 37F, and the time field 37G is stored respectively.

A plurality of transportation schedule proposals may be stored in the transportation schedule proposal information table 40. The transportation schedule proposal information table 40 may be generated for each transportation schedule proposal.

The charging schedule proposal information table 41 is a table that is generated along with the above-described transportation schedule proposal when an unexpected event occurs in a transportation schedule designed weekly or daily in advance and is used to manage the charging schedule proposal for the transportation vehicle 3 required to be charged. The charging schedule proposal information table 41 is generated for each charging base point 5B at which charging of any transportation vehicle 3 is scheduled.

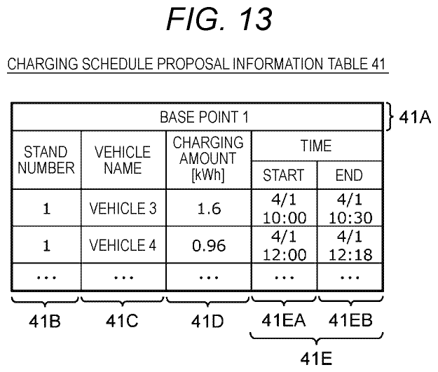

As illustrated in FIG. 13, the charging schedule proposal information table 41 includes a base point name field 41A, a stand number field 41B, a vehicle name field 41C, a charging amount field 41D, and a time field 41E. In the charging schedule proposal information table 41, one record (row) corresponds to one charging schedule for one transportation vehicle 3.

In the base point name field 41A, a base point name of the charging base point 5B to which the charging schedule proposal information table 41 corresponds is stored. In the stand number field 41B, a stand number of a charging stand installed at the corresponding charging base point 5B is stored. In the vehicle name field 41C, a vehicle name of the transportation vehicle 3 which should be charged at the charging stand is stored.

In the charging amount field 41D, a charging amount at the charging stand according to the generated charging schedule proposal is stored. The time field 41E is divided into a start field 41EA and an end field 41EB. In the start field 41EA, a time at which charging of the transportation vehicle 3 at the charging stand starts is stored. In the end field 41EB, a time at which the charging ends is stored.

Accordingly, in the case of the example of FIG. 13, a charging schedule proposal in which the transportation vehicle 3 called “vehicle 3” is charged at “1.6” kWh between “4/1 10:00” to “4/1 10:30” at the charging stand of which, for example, a stand number is “1” at the charging base point 5B called “base point 1” is generated.

Meanwhile, the schedule proposal generation unit 43 (FIG. 2) and the schedule proposal evaluation unit 44 (FIG. 2) are a functional unit implemented by causing CPU 10 of the transportation schedule generation apparatus 2 to execute a program stored in the ROM 11 or loaded from the auxiliary storage device 13 to the RAM 12.

The schedule proposal generation unit 43 has a function of generating combinations of a plurality of transportation schedule proposals and a plurality of charging schedule proposals in which unexpected events are considered when the unexpected events occur in the transportation schedule designed weekly or daily in advance. The schedule proposal evaluation unit 44 has a function of evaluating each transportation schedule proposal and each charging schedule proposal generated by the schedule proposal generation unit 43 and proposing a most appropriate combination of transportation schedule proposal and charging schedule proposal as a new transportation schedule to a user. Specific processing content of the schedule proposal generation unit 43 and the schedule proposal evaluation unit 44 will be described below.

### (3) Various Processes Performed in Relation to Transportation and Charging Schedule Proposal Generation and Evaluation Function

Next, specific processing content of various processes performed by the schedule proposal generation unit 43 and the schedule proposal evaluation unit 44 in relation to the transportation and charging schedule proposal generation and evaluation function will be described.

### (3-1) Transportation and Charging Schedule Proposal Generation and Evaluation Process

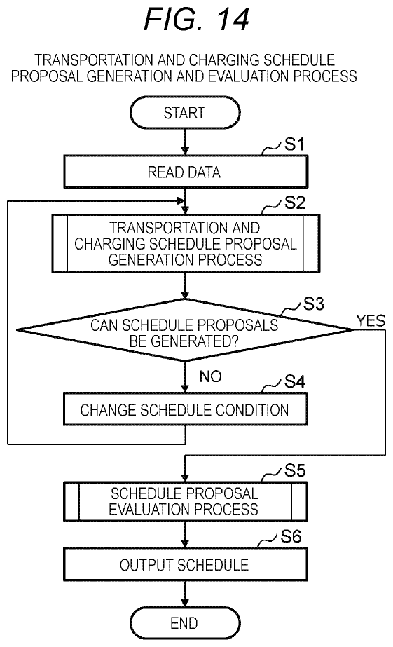

FIG. 14 illustrates a flow of a series of processes performed by the schedule proposal generation unit 43 and the schedule proposal evaluation unit 44 in relation to the transportation and charging schedule proposal generation and evaluation function (hereinafter referred to as a transportation and charging schedule proposal generation and evaluation process).

The transportation and charging schedule proposal generation and evaluation process is started using, as a trigger, an input of an instruction to generate a transportation schedule proposal and a charging schedule proposal to the transportation schedule generation apparatus 2 by an operator of a transportation service receiving a call indicating that an unexpected event occurs during execution of a transportation schedule designed weekly or daily in advance from a driver.

The schedule proposal generation unit 43 reads each piece of information stored in each of the respective tables described above in FIGS. 3 to 11 (S1).

Next, the schedule proposal generation unit 43 generates transportation schedule proposals and charging schedule proposals (S2). Here, the schedule proposal generation unit 43 generates combinations of the plurality of transportation schedule proposals and charging schedule proposals. The schedule proposal generation unit 43 stores the generated transportation schedule proposals in the transportation schedule proposal information table 40 (FIG. 12) and stores the generated charging schedule proposals in the charging schedule proposal information table 41 (FIG. 13).

Subsequently, the schedule proposal evaluation unit t 44 determines whether the schedule proposal generation unit 43 generated at least one combination of the transportation schedule proposal and the charging schedule proposal in step S2 (S3).

A negative result of step S3 means that the transportation schedule proposal and the charging schedule proposal cannot be generated under a present condition (a condition in generation of the transportation schedule proposal and the charging schedule proposal, and referred to as a schedule condition below) such as delivery of each load and an operation time of each transportation vehicle 3. Thus, here, the schedule proposal evaluation unit 44 changes the schedule condition (for example, delay of delivery of a load of a client destination in which delivery can be delayed, use of a new transportation vehicle 3 which can be used at the same day, or the like) and instructs the schedule proposal generation unit 43 to re-generate the transportation schedule proposal and the charging schedule proposal (S4). As a result, processes after step S2 are performed under the changed schedule condition as follows.

Conversely, when a positive result is obtained in step S3, the schedule proposal evaluation unit 44 evaluates each of three evaluation items including the “delivery delay”, the “operation time increase”, and the “operation time deviation” of each combination of the transportation schedule proposal and the charging schedule proposal generated in step S2 and overall evaluates the combination based on an evaluation result (S5).

Then, the schedule proposal evaluation unit 44 selects one combination of the transportation schedule proposal and the charging schedule proposal with the best evaluation based on the overall evaluation result of each combination of the transportation schedule proposal and the charging schedule proposal obtained in step S5, generates various screens according to the selected combination of the transportation schedule proposal and the charging schedule proposal, and outputs the screen data to the display device 15 of the transportation schedule generation apparatus 2 or each of the in-vehicle terminal 4 of each transportation vehicle 3 and the schedule management terminal 6 of each base point 5 (S6).

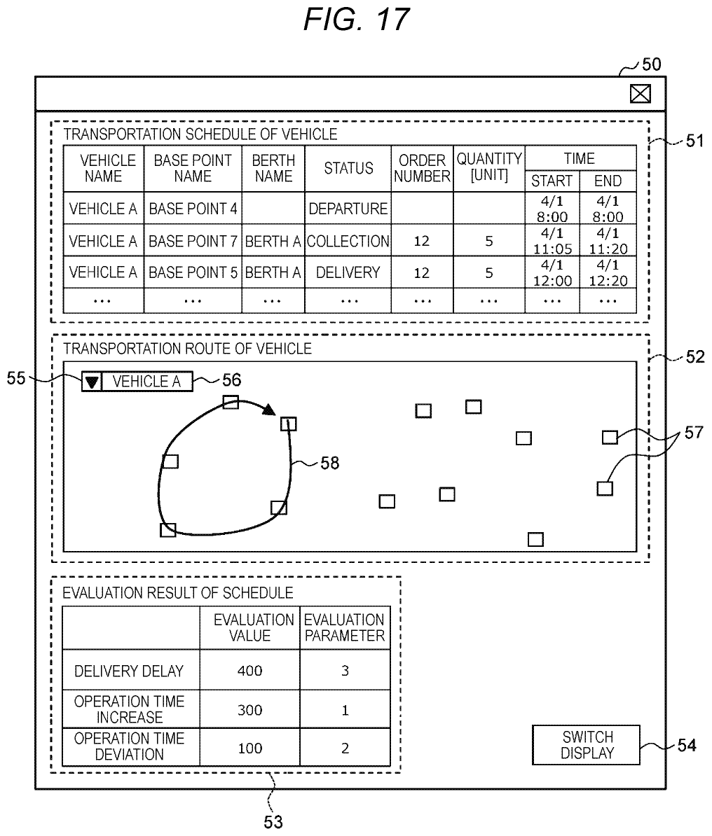

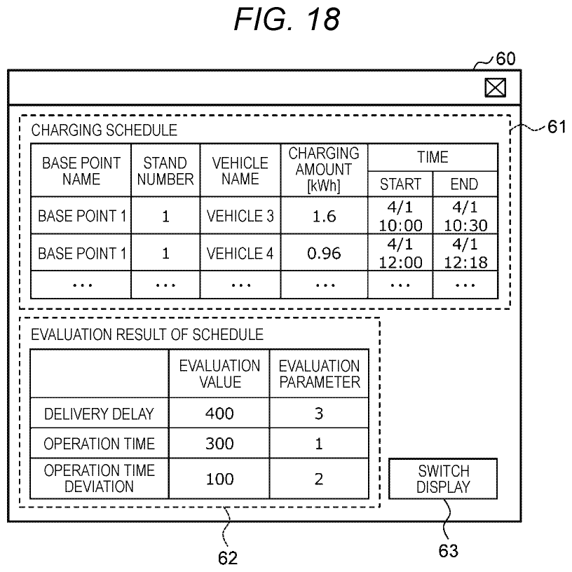

Specifically, the schedule proposal evaluation unit 44 generates a transportation schedule proposal display screen 50 to be described below in FIG. 17 or a charging schedule proposal display screen 60 to be described below in FIG. 18, and outputs screen data of the generated transportation schedule proposal display screen 50 or charging schedule proposal display screen 60 to the display device 15. Accordingly, the transportation schedule proposal display screen 50 or the charging schedule proposal display screen 60 is displayed on the display device 15 in response to a user operation.

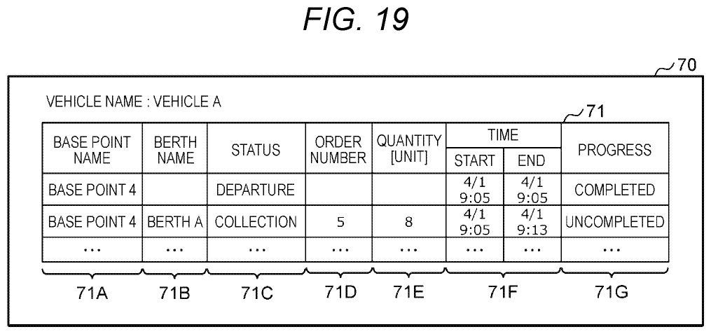

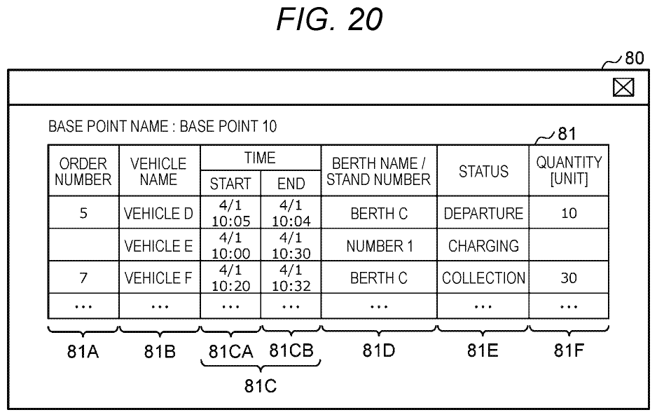

The schedule proposal evaluation unit 44 also generates a transportation schedule display screen 70 for each transportation vehicle 3 to be described below in FIG. 19 or a base point schedule display screen 80 for each base point 5 to be described below in FIG. 20. The schedule proposal evaluation unit 44 transmits screen data of each generated transportation schedule display screen 70 to the in-vehicle terminal 4 of the corresponding transportation vehicle 3 via the network 7, and transmits screen data of each generated base point schedule display screen 80 to the schedule management terminal 6 of the corresponding base point 5 via the network 7.

Accordingly, each corresponding transportation schedule display screen 70 is displayed on the display device 21 of each in-vehicle terminal 4, and each corresponding base point schedule display screen 80 is displayed on the display device 23 of each schedule management terminal.

As such, the transportation schedule proposal generation and evaluation process ends.

### (3-2) Transportation and Charging Schedule Proposal Generation Process

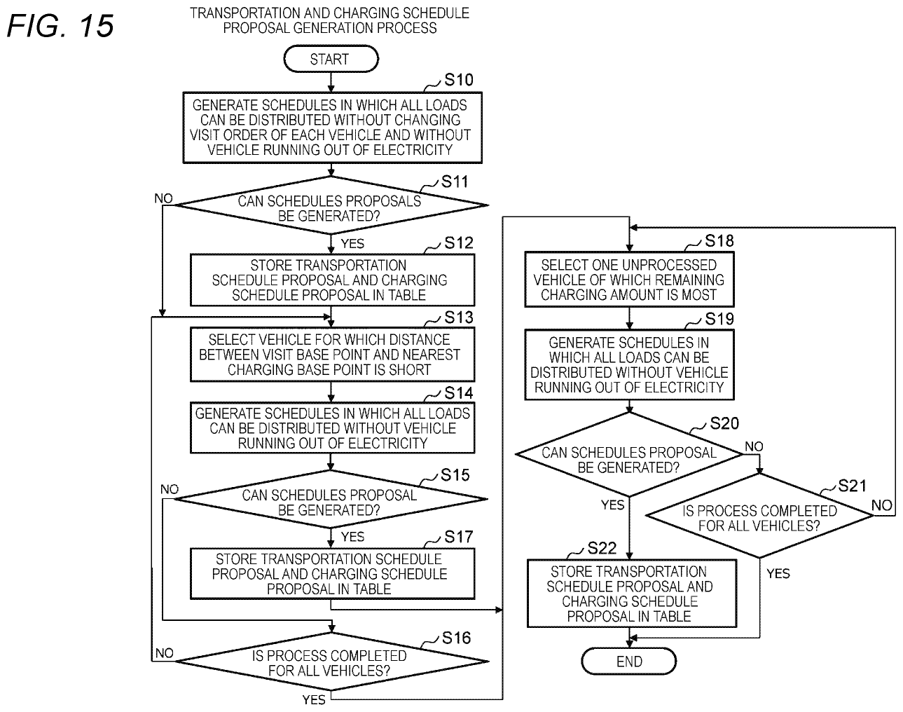

FIG. 15 illustrates content of a detailed process performed by the schedule proposal generation unit 43 (hereinafter referred to as a transportation and charging schedule proposal generation process) in step S2 of the transportation and charging schedule proposal generation and evaluation process described above in FIG. 14. The schedule proposal generation unit 43 generates the transportation schedule proposal and the charging schedule proposal satisfying the schedule condition according to the processing procedure illustrated in FIG. 15.

Actually, when the process proceeds to step S2 of the transportation and charging schedule proposal generation and evaluation process, the schedule proposal generation unit 43 starts the transportation and charging schedule proposal generation process illustrated in FIG. 15 and attempts to generate the plurality of transportation schedule proposals and charging schedule proposals in which a visit order of each transportation vehicle 3 to the base point 5 is not changed from the present transportation schedule read from the transportation schedule information table 37 (FIG. 9) in step S1 of the transportation and charging schedule proposal generation and evaluation process, any transportation vehicle 3 does not run out of electricity, and all loads to be transported can be transported (S10). Specifically, for the transportation vehicle 3 having a risk of running out of electricity, the schedule proposal generation unit 43 estimates a position less than a charging amount lower limit and attempts to generate a schedule in which a charging job is added at a base point scheduled to be visited by the transportation vehicle 3 beforehand.

The “transportation vehicle 3 having a risk of running out of electricity” can be identified by identifying the transportation vehicle 3 of which charging power is less than a charging amount lower limit as long as the transportation schedule is not changed based on the original transportation schedule stored in the transportation schedule information table 37 (FIG. 9), a present position and a remaining charging amount of each transportation vehicle 3 stored in the vehicle present-status information table 38 (FIG. 10), the charging amount lower limit and the electricity expense of each transportation vehicle 3 stored in the vehicle information table 32 (FIG. 4), and the movement distance between the base points 5 and the power movement coefficient stored in the movement cost information table 36 (FIG. 8). For example, a power consumption amount in a non-visit route when the transportation schedule is not changed can be calculated by multiplying the electricity expense of each transportation vehicle 3 by a power movement coefficient in the non-visit route and making comparison with a movement distance of the non-visit route.

Subsequently, the schedule proposal generation unit 43 determines whether the transportation schedule proposals and the charging schedule proposals can be generated in step S10 (S11). When a positive result is obtained in the determination, regarding each generated combination of the transportation schedule proposal and charging schedule proposal, the schedule proposal generation unit 43 stores the transportation schedule proposal in the transportation schedule proposal information table 40 (FIG. 12) and stores the charging schedule proposal in the charging schedule proposal information table 41 (FIG. 13) (S12).

Next, the schedule proposal generation unit 43 estimates a position at which the charging power is less than the charging amount lower limit in the original transportation schedule among the transportation vehicles 3 having a risk of running out of electricity, and selects one transportation vehicle 3 for which a distance between the collection and distribution base point 5A visited beforehand and the charging base point 5B nearest to the collection and distribution base point 5A is shortest and which is the transportation vehicle 3 on which the processes after step S13 were not processed for the above collection and distribution base point 5A and charging base point 5B (S13).

Subsequently, the schedule proposal generation unit 43 adds a visit to the charging base point 5B of the collection and distribution base point 5A and the charging base point 5B determined in step S13 to be closest to the transportation vehicle 3 selected in step S13 (hereinafter referred to as a selected vehicle) to the original transportation schedule, and attempts to generate a plurality of combinations of the transport schedule proposals and the charging schedule proposals in which all the loads to be transported and the transportation vehicle 3 does not run out of electricity (S14). For example, the schedule proposal generation unit 43 predicts a power amount consumed by the selected vehicle 3 in the original transportation schedule starting from the collection and distribution base point 5A until the delivery ends, and attempts to schedule for charging the predicted power amount at the charging base point 5B. The transportation schedule proposal generated here may be generated so that a difference from a job time or an increase amount of a movement time of each transportation vehicle 3 is small with respect to the original transportation schedule.

Thereafter, the schedule proposal generation unit 43 determines whether at least one combination of the transportation schedule proposal and the charging schedule proposal was generated in step S14 (S15).

When a negative result is obtained in the determination of S15, the schedule proposal generation unit 43 determines whether processes after step S13 were performed for all the transportation vehicles 3 (S16). When a negative result is obtained in the determination of S16, the process returns to step S13 and the schedule proposal generation unit 43 selects the transportation vehicle 3 in step S13 in addition to the selected vehicle 3 from the other transportation vehicle 3 for which the processes after step S14 were not performed, and repeats the processes of steps S13 to S16 as described above.

When a positive result is not obtained in step S15 even in the repeated processes of steps S13 to S16 (that is, when the combinations of the transportation schedule proposals and the charging schedule proposals in which all the loads to be transported are transported and the transportation vehicle 3 does not run out of electricity cannot be generated), the schedule proposal generation unit 43 moves to step S18.

Conversely, when the positive result is obtained in step S15 in the repeated processes of steps S13 to S16 (that is, when at least one combination of the transportation schedule proposal and the charging schedule proposal in which all the loads to be transported are transported and the transportation vehicle 3 does not run out of electricity can be generated), regarding each generated combination of the transportation schedule proposal and the charging schedule proposal, the schedule proposal generation unit 43 stores the transportation schedule proposal in the transportation schedule proposal information table 40 (FIG. 12) and stores the charging schedule proposal in the charging schedule proposal information table 41 (FIG. 13) (S17).

Subsequently, the schedule proposal generation unit 43 selects one transportation vehicle 3 of which a remaining charging amount is the most (S18). Here, the “remaining charging amount” may be a present remaining charging amount of each transportation vehicle 3 acquired from the vehicle information table 32 (FIG. 4) or may be a remaining charging amount of each transportation vehicle 3 after each transportation vehicle 3 is moved according to the original transportation schedule estimated based on each piece of information stored in the transportation schedule information table 37 (FIG. 9) and the movement cost information table 36 (FIG. 8).

Next, the schedule proposal generation unit 43 preferentially permits addition of a visit base point or extension of the operation time for the transportation vehicle 3 selected in step S18 (hereinafter referred to as a selected vehicle) and attempts to generate a plurality of combinations of the transportation schedule proposals and the charging schedule proposals in which all the loads can be distributed and there is no transportation vehicle 3 running out of electricity (S19). For example, the schedule proposal generation unit 43 attempts to generate a schedule in which the selected vehicle 3 is in charge of a part of the delivery of the transportation vehicle 3 running out of electricity in the original transportation schedule. The transportation schedule proposal generated here may be generated so that a difference in a job time or an increase amount of a movement time of each transportation vehicle 3 is small with respect to the original transportation schedule stored in the transportation schedule information table 37. Thereafter, the schedule proposal generation unit 43 determines whether at least one combination of the transportation schedule proposal and the charging schedule proposal was generated in step S19 (the charging schedule proposal is unnecessary when there is no transportation vehicle 3 of which charging is necessary in the generated transportation schedule proposal) (S20).

When a negative result is obtained in the determination, the schedule proposal generation unit 43 determines whether processes after step S18 were performed for all the transportation vehicles 3 (S21). When a negative result is obtained in the determination of S21, the process returns to step S18 and the schedule proposal generation unit 43 selects the transportation vehicle 3 in step S18 in addition to the selected vehicle 3 from the other corresponding transportation vehicle 3 for which the processes after step S17 were not performed and repeats the processes of steps S18 to S21 as described above.

When a positive result is obtained in step S20 in the repeated processes of steps S18 to S21 (that is, when at least one combination of the transportation schedule proposal and the charging schedule proposal in which all the loads to be transported are transported and the transportation vehicle 3 does not run out of electricity can be generated), regarding each generated combination of the transportation schedule proposal and the charging schedule proposal, the schedule proposal generation unit 43 stores each transportation schedule proposal in the transportation schedule proposal information table 40 and stores the charging schedule proposal in the charging schedule proposal information table 41 (S22). Then, the schedule proposal generation unit 43 subsequently ends the transportation and charging schedule proposal generation process.

Conversely, when the positive result is not obtained in step S20 and the positive result is obtained in step S21 in the repeated processes of steps S18 to S21 (that is, the combinations of the transportation schedule proposals and the charging schedule proposals in which all the loads to be transported are transported and the transportation vehicle 3 does not run out of electricity cannot be generated and the process of step S19 ends for all the transportation vehicles 3), the schedule proposal generation unit 43 ends the transportation and charging schedule proposal generation and evaluation process.

### (3-3) Schedule Proposal Evaluation Process

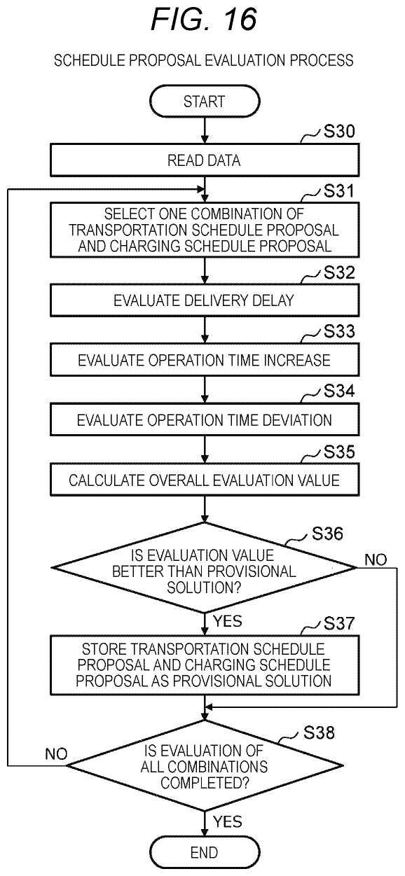

FIG. 16 illustrates content of a detailed process performed by the schedule proposal evaluation unit 44 in step S5 of the transportation schedule proposal generation and evaluation process described above in FIG. 14 (hereinafter referred to as a schedule proposal evaluation process). The schedule proposal evaluation unit 44 evaluates the combinations of the transportation schedule proposals and the charging schedule proposals generated by the schedule proposal generation unit 43 according to the processing procedure of FIG. 16 from three viewpoints of the above-described “delivery delay”, the “operation time increase”, and the “operation time deviation”. At least the “delivery delay” is set as an evaluation item and the evaluation item may be changed, added, or deleted.

Actually, when the process proceeds to step S5 of the transportation and charging schedule proposal generation and evaluation process, the schedule proposal evaluation unit 44 starts the schedule proposal generation process illustrated in FIG. 16. First, the schedule proposal evaluation unit 44 reads all the transportation schedule proposal and the charging schedule proposal respectively stored in the transportation schedule proposal information table 40 and the charging schedule proposal information table 41 (S30).

Subsequently, the schedule proposal evaluation unit 44 selects one combination of the transportation schedule proposal and the charging schedule proposal for which the processes after step S32 were not performed among the combinations of the transportation schedule proposals and the charging schedule proposals generated by the schedule proposal generation unit 43 (S31).

Next, the schedule proposal evaluation unit 44 evaluates the “delivery delay” of the combination of the transportation schedule proposal and the charging schedule proposal selected in step S31 (hereinafter referred to as selected combination) (S32). Specifically, the schedule proposal evaluation unit 44 uses various types of information stored in the load information table 31 (FIG. 3) and the transportation schedule proposal information table 40 acquired in step S30 to calculate a sum of delay times of deliveries of each of the loads in the selected combination as an evaluation value for the “delivery delay” (hereinafter referred to as a delivery delay evaluation value) by the following formula.

$$[ Expression . 1 ]$$

$$delivery delay evaluation value = \sum load not following collection time range constraint ( divergence from collection time range ) + \sum load not following delivery time range constraint ( divergence from delivery time range ) \qquad ( 1 )$$

Here, “divergence from collection time range” in Formula (1) is a time difference between a time of a collection time range (the collectable date and time 31E of the load information table 31) and a time of collection in the transportation schedule proposal (the time 40G of the transportation schedule proposal information table 40). For example, when the collection time range is 13:00 to 15:00 and an actual collection time is 18:00 to 18:15, “divergence from collection time range” is 3 hours 15 minutes which is a time difference between an end time of the collection time range and an actual collection end time.

Similarly, “divergence from delivery time range” in Formula (1) is a time difference between a time of a delivery time range (the deliverable date and time 31F of the load information table 31) and a delivery time in the transportation schedule proposal (the time 40G of the transportation schedule proposal information table 40).

Here, the delivery delay evaluation value may be calculated using each piece of information stored in the transportation schedule information table 37 (FIG. 9) and the transportation schedule proposal information table 40 by the following formula.

$$[ Expression . 2 ]$$

$$delivery delay evaluation value = \sum load \vert collection start time of transportation schedule proposal - collection start time of original transportation schedule \vert + \sum load \vert delivery start time of transportation schedule proposal - delivery start time of original transportation schedule \vert \qquad ( 2 )$$

Here, “collection start time of transportation schedule proposal” and “delivery start time of transportation schedule proposal” in Formula (2) are acquired from the start time 40GA in the row of the transportation schedule proposal information table 40 in which the status is “collection” and “delivery”, and “collection start time of original transportation schedule” and “delivery start time of original transportation schedule” are acquired from the start time 37GA in the row of the transportation schedule information table 37 in which the status is “collection” and “delivery”.

Subsequently, the schedule proposal evaluation unit 44 evaluates “operation time increase” of the selected combination (S33). Specifically, the schedule proposal evaluation unit 44 uses each piece of information stored in the transportation schedule information table 37 and the transportation schedule proposal information table 40 to calculate a difference between the operation time in the transportation schedule proposal of the selected combination and the operation time in the original transportation schedule as an evaluation value for the “operation time increase” (hereinafter referred to as an operation time increase evaluation value).

$$[ Expression . 3 ]$$

$$operation time increase evaluation value = \sum vehicle ( operation time of transportation schedule proposal - operation time of original time of original transportation schedule ) \qquad ( 3 )$$

Here, “operation time of transportation schedule proposal” in Formula (3) is a time difference between a time at which the “departure” job is performed in the transportation schedule proposal (the start time 40GA of the row in which the status is “departure” in the transportation schedule proposal information table 40) and a time at which the “arrival” job is performed in the transportation schedule proposal (the start time 40GA of the row in which the status is “arrival” in the transportation schedule proposal information table 40). Similarly, “operation time of original transportation schedule” is a time difference between a time at which the “departure” job is performed in the original transportation schedule (the start time 40GA of the row in which the status is “departure” in the transportation schedule information table 37) and a time at which the “arrival” job is performed in the original transportation schedule (the start time 40GA of the row in which the status is “arrival” in the transportation schedule information table 37).

Here, the operation time increase evaluation value may be calculated using various types of information stored in the vehicle information table 32 (FIG. 4) and the transportation schedule proposal information table 40 by the following formula.

$$[ Expression . 4 ]$$

$$operation time increase evaluation value = \sum vehicle not following operation time upper limit in transportation schedule proposal ( operation time of transporation schedule proposal - operation time upper limit ) - \sum vehicle not following operation time upper limit in original transportation schedule ( operation time of original transportation schedule - operation time upper limit ) \qquad ( 4 )$$

Here, “operation time in transportation schedule proposal” and “operation time of original transportation schedule” in Formula (4) are calculated similarly to Formula (3). “Operation time upper limit” is acquired from the operation time upper limit 32C in the vehicle information table 32.

The schedule proposal evaluation unit 44 evaluates “operation time deviation” of the selected combination (S34). Specifically, the schedule proposal evaluation unit 44 uses various types of information stored in the transportation schedule information table 37 and the transportation schedule proposal information table 40 to calculate a difference between the operation time deviation in the transportation schedule proposal of the selected combination and the operation time deviation in the original transportation schedule as an evaluation value for “operation time deviation” (hereinafter referred to as an operation time deviation evaluation value) by the following formula. Here, “operation time of transportation schedule proposal” and “operation time of original transportation schedule” in Formula (5) are calculated similarly to Formula (3) to obtain a deviation.

$$[ Expression . 5 ]$$

$$operation time deviation evaluation value = operation time deviation in transportation schedule proposal - operation time deviation in original transportation schedule \qquad ( 5 )$$

Subsequently, the schedule proposal evaluation unit 44 calculates an overall evaluation value for the selected combination (hereinafter referred to as an overall evaluation value) by the following formula based on parameters (weight coefficients) set in advance for each of the evaluation items including the “delivery delay”, “operation time increase”, and the “operation time deviation” stored in the evaluation information table 39 (FIG. 11), the delivery delay evaluation value calculated in step S32, the operation time increase evaluation value calculated in step S33, and the operation time deviation evaluation value calculated in step S34 (S35). Here, α1, α2, and α3 are the delivery delay parameter 39A, the operation time increase parameter 39B, and the operation time deviation parameter 39C, respectively, in the case of the evaluation information table 39.

$$[ Expression . 6 ]$$

$$schedule proposal overall - evaluation value = delivery delay evaluation value \times α 1 + operation time increase evaluation value \times α 2 + operation time deviation evaluation value \times α 3 \qquad ( 6 )$$

Subsequently, the schedule proposal evaluation unit 44 determines whether the overall evaluation value calculated in step S35 is better (smaller) than the provisional solution until then (S36). When a negative result is obtained in the determination, the schedule proposal evaluation unit 44 moves to step S38.

Conversely, when a positive result is obtained in the determination of step S36, the schedule proposal evaluation unit 44 stores the selected combination as a provisional solution (S37). The schedule proposal evaluation unit 44 omits step S36 and stores the selected combination as a provisional solution when the overall evaluation value calculated in immediately previous step S35 is a first calculated evaluation value.

The schedule proposal evaluation unit 44 determines whether there is no combination of the transportation schedule proposal and the charging schedule proposal for which the processes after step S32 is not performed among the combinations of the transportation schedule proposals and the charging schedule proposals generated until then and evaluations of all the combinations were completed (S38).

When a negative result is obtained in the determination, the process returns to step S31 and the schedule proposal evaluation unit 44 subsequently repeats the processes of steps S31 to S38 until a positive result is obtained in step S38 while sequentially changing the combination of the transportation schedule proposal and the charging schedule proposal selected in step S31 to the combination of the transportation schedule proposal and the charging schedule proposal for which the processes after step S32 were not performed.

When the schedule proposal evaluation unit 44 completes the overall evaluation value for all the combinations of the transportation schedule proposals and the charging schedule proposals generated by the schedule proposal generation unit 43 and a positive result is obtained in step S38, the schedule proposal evaluation process is ended.

### (4) Configurations of Various Screens

### (4-1) Transportation Schedule Proposal Display Screen

FIG. 17 illustrates a configuration example of the transportation schedule proposal display screen 50 displayed on the display device 15 by the schedule proposal evaluation unit 44 in step S6 of the transportation and charging schedule proposal generation and evaluation process described above in FIG. 14. The transportation schedule proposal display screen 50 includes a transportation schedule display region 51, a transportation route display region 52, and an evaluation result display region 53.

In the transportation schedule display region 51, a transportation schedule of a load by each transportation vehicle 3 in the transportation schedule proposal included in the combination of the transportation schedule proposal and the charging schedule proposal in which the overall evaluation value is stored as a final provisional solution in step S37 of the schedule proposal evaluation process described above in FIG. 16 (hereinafter referred to as an optimum combination) is displayed in a similar format to the transportation schedule proposal information table 40 described above in FIG. 12.

In the transportation route display region 52, a pull-down menu button 55 and a vehicle name display field 56 are provided. By clicking the pull-down menu button 55, it is possible to display a pull-down menu (not illustrated) in which vehicle names of all the transportation vehicles 3 for which a transportation schedule in the transportation schedule proposal included in the optimum combination is generated are posted.

In the transportation route display region 52, by clicking a vehicle name of the transportation vehicle 3 desired among the vehicle names posted in the pull-down menu, the transportation vehicle 3 can be selected, and the vehicle name of the selected transportation vehicle 3 (hereinafter referred to as a selected vehicle) is displayed in the vehicle name display field 56.

When the desired transportation vehicle 3 is selected as described above, a map (not illustrated) near a transportation route of the selected vehicle 3 is displayed inside the transportation route display region 52. A base point mark 57 indicating a position of each base point 5 is displayed on the map and a transportation route of the selected vehicle 3 is displayed with an arrow 58.

In the evaluation result display region 53, evaluation values (the delivery delay evaluation value, the operation time increase evaluation value, the operation time deviation evaluation value) of the evaluation items (the “delivery delay”, the “operation time increase”, the “operation time deviation”) for the optimum combination and values of the evaluation parameters (weight coefficients) set in advance for the evaluation items are displayed in a table format.

In the transportation schedule proposal display screen 50, a display switch button 54 is provided on the right of the evaluation result display region 53. By clicking the display switch button 54, it is possible to switch a display screen of the display device 15 from the transportation schedule proposal display screen 50 to the charging schedule proposal display screen 60 illustrated in FIG. 18.

The charging schedule proposal display screen 60 includes a charging schedule display region 61 and an evaluation result display region 62. In the charging schedule display region 61, a charging schedule of each transportation vehicle 3 which is a target in the charging schedule proposal included in the optical combination is displayed in a similar table format to the charging schedule proposal information table 41 described in FIG. 13.

Here, the charging schedule proposal information table 41 is generated for each charging base point 5B (including the collection and distribution base points 5A having a charging stand). However, the table displayed in the charging schedule display region 61 is different from the charging schedule proposal information table 41 in that each base point name (a field displayed as “base point name” in FIG. 18) is provided for each record (row) and a base point name of the charging base point 5B at which the corresponding charging stand is installed is displayed in the base point name field.

In the evaluation result display region 62, similarly to the evaluation result display region 53 of the transportation schedule proposal display screen 50, evaluation values (the delivery delay evaluation value, the operation time increase evaluation value, the operation time deviation evaluation value) of the evaluation items for the transportation schedule proposal and the charging schedule proposal configuring the corresponding optimum combination and values of the evaluation parameters set in advance for the evaluation items are displayed in a table format.

In the charging schedule proposal display screen 60, a display switch button 63 is provided on the right of the evaluation result display region 62. By clicking the display switch button 63, it is possible to switch a display screen of the display device 15 from the charging schedule proposal display screen 60 to the transportation schedule proposal display screen 50 described above in FIG. 17.

### (4-2) Transportation Schedule Display Screen

Meanwhile, FIG. 19 illustrates a transportation schedule display screen 70 displayed in each in-vehicle terminal 4 based on a transportation schedule transmitted from the schedule proposal evaluation unit 44 to each in-vehicle terminal 4 of each transportation vehicle 3 in step S6 of the transportation and charging schedule proposal generation and evaluation process described above in FIG. 14.

In the transportation schedule display screen 70, a transportation schedule table 71 in which a transportation schedule of the transportation vehicle 3 mounted with the in-vehicle terminal 4 is registered among the transportation schedules of the transportation vehicles 3 in the transportation schedule proposal of the optimum combination is displayed.

The transportation schedule table 71 includes a base point name field 71A, a berth name field 71B, a status field 71C, an order number field 71D, a quantity field 71E, a time field 71F, and a progress field 71G. In the transportation schedule table 71, one record (row) corresponds to one status (departure, collection, delivery, charging, arrival, or the like) performed by the corresponding transportation vehicle 3 at any base point 5.

In the base point name field 71A, the berth name field 71B, the status field 71C, the order number field 71D, the quantity field 71E, and the time field 71F, similar information to the information stored in the base point name field 40B, the berth name field 40C, the status field 40D, the order number field 40E, the quantity field 40F, and the time field 40G of the record corresponding to the corresponding transportation vehicle 3 in the transportation schedule proposal information table 40 described above in FIG. 12 is displayed.

In the progress field 71G, information indicating whether the corresponding transportation vehicle 3 completed the status corresponding to the record is displayed. In the case of the example of FIG. 19, when the transportation vehicle 3 completed the corresponding status, information “completed” is displayed. When the transportation vehicle 3 did not complete the corresponding status, information “uncompleted” is displayed.

By displaying the transportation schedule display screen 70 in the in-vehicle terminal 4 of each transportation vehicle 3, a driver of each transportation vehicle 3 can confirm a future transportation schedule of the transportation vehicle 3 driven by the driver or a progress status of the transportation schedule easily in real time even when the transportation schedule is changed due to occurrence of unexpected events.

### (4-3) Base Point Schedule Display Screen

Meanwhile, FIG. 20 illustrates a base point schedule display screen 80 displayed in each schedule management terminal 6 of each base point 5 based on a job schedule of each base point 5 transmitted from the schedule proposal evaluation unit 44 to each schedule management terminal 6 in step S6 of the transportation and charging schedule proposal generation and evaluation process described above in FIG. 14.

In the base point schedule display screen 80, a base point schedule table 81 is displayed in which a schedule of each job (collection, delivery, charging, or the like) (hereinafter referred to as a job schedule) determined in the transportation schedule proposal and the charging schedule proposal of the optimum combination to be performed by each transportation vehicle 3 at the corresponding base point 5 is registered. Here, “job” is the same as the above-described “status”.

The base point schedule table 81 includes an order number field 81A, a vehicle name field 81B, a time field 81C, a berth name/stand number field 81D, a status field 81E, and a quantity field 81F. In the base point schedule table 81, one record (row) corresponds to one job performed on each transportation vehicle 3 at the corresponding base point 5.

In the order number field 81A, an order number of an order which is a corresponding job target is displayed. In the vehicle name field 81B, a vehicle name of the transportation vehicle 3 which is a corresponding job target is stored. The time field 81C is divided into a start field 81CA and an end field 81CB. A date and time at which a corresponding job starts to be performed is displayed in the start field 81CA, and a date and time of the job end time is displayed in the end field 81CB.

In the berth name/stand number field 81D, a berth number of a berth or a stand number of a charging stand in which the job is performed are displayed. In the status field 81E, specific content of the job (“status”) is displayed. In the quantity field 81F, the quantity of loads on which the job is performed is displayed.

In the base point schedule table 81, in addition to or instead of the quantity of loads, some or all of a weight, a volume, a length, a width, and a height may be displayed. In the base point schedule display screen 80, schedules of charging and schedules of other jobs may be separately displayed.

By respectively displaying the base point schedule display screen 80 in each schedule management terminal 6 of each base point, a worker of each base point can confirm a future schedule of a job performed by themselves easily in real time even when the transportation schedule is changed due to occurrence of unexpected events.

### (5) Advantages of Embodiment

In the transportation schedule generation system 1 according to the above-described embodiment, when an unexpected event occurs in a pre-generated transportation schedule, the transportation schedule generation apparatus 2 generates a plurality of combinations of the transportation schedule proposals and the charging schedule proposals in which the unexpected event is taken into consideration, evaluates each of three evaluation items including the “delivery delay”, the “operation time increase”, and the “operation time deviation” with respect to each of the generated combinations of the proposal schedule proposals and the charging schedule proposals, selects a more better evaluated combination of the transportation schedule proposal and the charging schedule proposal as a new transportation schedule based on evaluation results of the evaluation items, and presents the selected combination to a user such as an operator of the transportation service, a driver of each transportation vehicle, or a staff of each base point.

Accordingly, the transportation schedule generation system 1 can generate a best new transportation schedule (the transportation schedule proposal and the charging schedule proposal) with which the delivery delay of the loads, the operation time increase of the transportation vehicle, and the operation time deviation can be inhibited and can thus generate the new transportation schedule with which an increase in the logistics cost is inhibited.

### (6) Other Embodiments

In the above-described embodiment, the case where one computer apparatus configuring the transportation schedule generation apparatus 2 is mounted with the transportation and charging schedule proposal generation and evaluation function according to the embodiment was described, but the present invention is not limited thereto. The transportation and charging schedule proposal generation and evaluation function according to the embodiment may be distributed and mounted in a plurality of computer apparatuses included in a distributed computing system.

In the above-described embodiment, the case where the transportation schedule proposal in the transportation schedule proposal and charging schedule proposal selected finally as the new transportation proposal is displayed in the transportation schedule proposal display screen 50 and the charging schedule proposal is displayed in the charging schedule proposal display screen 60 was described, but the present invention is not limited thereto. The transportation schedule proposal and the charging schedule proposal may be collectively displayed in one screen.

In the above-described embodiment, the case where the schedule proposal evaluation unit 44 selects one combination of the transportation schedule proposal and charging schedule proposal as a new transportation schedule was described, but the present invention is not limited thereto. A plurality of combinations of transportation schedule proposals and charging schedule proposals which are Pareto optimum may be presented to a user such as an operator, and the user may be able to select a desired combination from the presented combinations of the transportation schedule proposals and the charging schedule proposals.

For example, a plurality of sets of the evaluation parameters (for example, the delivery delay parameter, the operation time increase parameter, the operation time deviation parameter, and the like) of the evaluation items may be prepared, and the schedule proposal evaluation unit 44 may extract an optimum combination of the transportation schedule proposal and the charging schedule proposal for each set of the evaluation parameters, display the extracted optimum combinations of the transportation schedule proposal and the charging schedule proposal, and allow the operator to select one desired optimum combination.

In the schedule proposal evaluation process of FIG. 16, a predetermined number of combinations (the combinations of the transportation schedule proposals and the charging schedule proposals) in which the overall evaluation value is not the highest but the overall evaluation value is highly ranked may be selected, the combinations may be displayed along with the individual evaluation values or the overall evaluation value on the display device 15, and the operator may be allowed to select (determine) the combination to be applied as a new transportation schedule and charging schedule with the input device 14 or the like. People concerned are notified of the combination selected by the operator on the screens illustrated in FIGS. 17 to 20 or the like.

In the above-described embodiment, the case where the plurality of combinations of the transportation schedule proposals and the charging schedule proposals are generated was described, but the present invention is not limited thereto. A plurality of combinations of the transportation schedule proposals and supply schedule proposals for charging or exchanging a battery included in the transportation vehicle 3 that is necessary for each transportation vehicle 3 to not run out of electricity when the transportation schedule proposal is being performed may be generated. Information regarding the battery to be exchanged can be input, for example, by storing an identification number of the battery in the stand number and storing “exchange” in a charging mode in FIG. 7. When a schedule for exchanging the battery is designed, for example, “exchange” is stored in the status in the transportation schedule proposal information table 40 of FIG. 12, the identification number of the battery is stored in the stand number, and a charging amount increased by exchanging the battery is stored in a charging amount in the charging schedule proposal information table 41 of FIG. 13. An evaluation process and an output process may be performed for the combinations of the transportation schedule proposals and the supply schedule proposals.

The present invention can be applied to a transportation schedule generation system re-generating a pre-generated transportation schedule of a load by a transportation vehicle configured as a motor vehicle.

What is claimed is:

1. A transportation schedule generation system that re-generates a pre-generated transportation schedule of loads by transportation vehicles which are motor vehicles, the system comprising:
a schedule proposal generation unit configured to generate a plurality of combinations of transportation schedule proposals of the loads in which the loads to be transported are transported without the transportation vehicles running out of electricity and charging schedule proposals of the transportation vehicles based on the original transportation schedule and a remaining charging amount of each of the present transportation vehicles; and
a schedule proposal evaluation unit configured to evaluate at least a delivery delay of the loads for each of the generated combinations of the transportation schedule proposals and the charging schedule proposals and select a combination of the transportation schedule proposal and the charging schedule proposal based on an evaluation result.

2. The transportation schedule generation system according to claim 1, wherein the schedule proposal evaluation unit evaluates each evaluation item of the delivery delay of the load, an operation time increase of the transportation vehicle, and an operation time deviation of the transportation vehicle for each of the combinations of the transportation schedule proposals and the charging schedule proposals generated by the schedule proposal generation unit, overall evaluates the combinations based on an evaluation result of each evaluation item, and selects a combination of the transportation schedule proposal and the charging schedule proposal based on an overall evaluation result.

3. The transportation schedule generation system according to claim 1, wherein the schedule proposal generation unit adds or changes visit base points of the transportation vehicles and generates combinations of the transportation schedule proposals of the loads and the charging schedule proposals of the transportation vehicles in which the loads to be transported are all transported without the transportation vehicle running out of electricity.

4. The transportation schedule generation system according to claim 3, wherein the schedule proposal generation unit generates combinations of the transportation schedule proposals of the loads and the charging schedule proposals of the transportation vehicles considering a movement cost between the base points in addition to remaining charging amounts of the transportation vehicles.

5. The transportation schedule generation system according to claim 2, wherein the schedule proposal generation unit manages a weight coefficient of each of the set evaluation items,
calculates an evaluation value of each of the evaluation items with regard to each of the combinations of the transportation schedule proposals and the charging schedule proposals, and calculates, as an overall evaluation value, a total sum of multiplication results obtained by multiplying the evaluation values of the evaluation items by the corresponding weight coefficients, and
selects a combination of the transportation schedule proposal and the charging schedule proposal based on the calculated overall evaluation value for each of the combinations of the transportation schedule proposals and the charging schedule proposals.

6. The transportation schedule generation system according to claim 1, further comprising:
a display device configured to display information, wherein
the schedule proposal evaluation unit displays information regarding the selected combination of the transportation schedule proposal and the charging schedule proposal on the display device.

7. The transportation schedule generation system according to claim 6, wherein
the schedule proposal evaluation unit evaluates each evaluation item of the delivery delay of the load, an operation time increase of the transportation vehicle, and an operation time deviation of the transportation vehicle for each of the combinations of the transportation schedule proposals and the charging schedule proposals generated by the schedule proposal generation unit, overall evaluates the combinations based on an evaluation result of each evaluation item, and selects a combination of the transportation schedule proposal and the charging schedule proposal based on an overall evaluation result, and
the information displayed on the display device includes an evaluation result of each of the evaluation items with regard to the combination of the transportation schedule proposal and the charging schedule proposal selected as the transportation schedule.

8. The transportation schedule generation system according to claim 1, further comprising:
an in-vehicle terminal mounted in each of the transportation vehicles, wherein
the schedule proposal evaluation unit transmits a transportation schedule of each of the transportation vehicles included in the selected combination of the transportation schedule proposal and the charging schedule proposal to the in-vehicle terminal of the corresponding transportation vehicle, and
each of the in-vehicle terminals displays the transportation schedule transmitted from the schedule proposal evaluation unit.

9. The transportation schedule generation system according to claim 1, further comprising:
a schedule management terminal installed at each base point at which collection or delivery of the loads or charging of the transportation vehicle is performed, wherein
the schedule proposal evaluation unit transmits a job schedule of each base point included in the combination of the transportation schedule proposal and the charging schedule proposal selected as a new transportation schedule to the schedule management terminal of each corresponding base point, and
each schedule management terminal displays the job schedule transmitted from the schedule proposal evaluation unit.

10. A transportation schedule generation method performed in a transportation schedule generation system including a transportation schedule generation apparatus that re-generates a pre-generated transportation schedule of loads by transportation vehicles which are motor vehicles, the method comprising:
a first step of generating a plurality of combinations of transportation schedule proposals of the loads in which the loads to be transported are transported without t the transportation vehicles running out of electricity and charging schedule proposals of the transportation vehicles based on the original transportation schedule and a remaining charging amount of each of the present transportation vehicles; and
a second step of evaluating at least a delivery delay of the loads for each of the generated combinations of the transportation schedule proposals and the charging schedule proposals and selecting a combination of the transportation schedule proposal and the charging schedule proposal based on an evaluation result.

11. The transportation schedule generation method according to claim 10, wherein the transportation schedule generation system evaluates each evaluation item of the delivery delay of the load, an operation time increase of the transportation vehicle, and an operation time deviation of the transportation vehicle for each of the generated combinations of the transportation schedule proposals and the charging proposals, the schedule overall evaluates combinations based on an evaluation result of each evaluation item, and selects a combination of the transportation schedule proposal and the charging schedule proposal based on an overall evaluation result in the second step.

12. The transportation schedule generation method according to claim 10, wherein the transportation schedule generation system adds or changes visit base points of the transportation vehicles and generates combinations of the transportation schedule proposals of the loads and the charging schedule proposals of the transportation vehicles in which the loads to be transported are all transported without the transportation vehicle running out of electricity in the first step.

13. The transportation schedule generation method according to claim 12, wherein the transportation schedule generation system generates combinations of the transportation schedule proposals of the loads and the charging schedule proposals of the transportation vehicles considering a movement cost between the base points in addition to remaining charging amounts of the transportation vehicles in the first step.

14. The transportation schedule generation method according to claim 11, wherein the transportation schedule generation system
manages a weight coefficient of each of the set evaluation items,
calculates an evaluation value of each of the evaluation items with regard to each of the combinations of the transportation schedule proposals and the charging schedule proposals, and calculates, as an overall evaluation value, a total sum of multiplication results obtained by multiplying the evaluation values of the evaluation items by the corresponding weight coefficients, and
selects a combination of the transportation schedule proposal and the charging schedule proposal based on the calculated overall evaluation value for each of the combinations of the transportation schedule proposals and the charging schedule proposals in the first step.

15. The transportation schedule generation method according to claim 10, wherein the transportation schedule generation system displays information regarding the combination of the transportation schedule proposal and the charging schedule proposal selected as the transportation schedule in the first step.

16. A transportation schedule generation system that re-generates a pre-generated transportation schedule of loads by transportation vehicles which are motor vehicles, the system comprising:
a schedule proposal generation unit configured to generate a plurality of combinations of transportation schedule proposals of the loads in which the loads to be transported are transported without the transportation vehicles running out of electricity and supply schedule proposals of the transportation vehicles based on the original transportation schedule and a remaining charging amount of each of the present transportation vehicles; and
a schedule proposal evaluation unit configured to evaluate at least a delivery delay of the loads for each of the generated combinations of the transportation schedule proposals and the supply schedule proposals and select a combination of the transportation schedule proposal and the supply schedule proposal based on an evaluation result.

17. The transportation schedule generation system according to claim 16, wherein the supply schedule proposal is a schedule proposal including at least one of a schedule in which batteries of the transportation vehicles are charged and a schedule in which the batteries of the transportation vehicles are exchanged.
